(19) United States
(12) Patent Application Publication
(10) Pub. No.: US 2017/0332222 A1
(43) Pub. Date: Nov. 16, 2017

(54) METHODS TO PRIORITIZE MOBILE ORIGINATED EMERGENCY CALLS OVER EXISTING MOBILE TERMINATED CALL RELATED SIGNALING ON OTHER SUBSCRIPTION

(71) Applicant: QUALCOMM Incorporated, San Diego, CA (US)

(72) Inventors: Shravan Kumar RAGHUNATHAN, San Diego, CA (US); Nikhil CHALLA, San Diego, CA (US); Anand Chowdhary KOLLURI, San Diego, CA (US); Uttam Pattanayak, San Diego, CA (US); Yongsheng SHI, San Diego, CA (US); Krishna Rao MANDADAPU, San Diego, CA (US); Ai Ping ZHANG, San Diego, CA (US); Muthukumaran DHANAPAL, San Diego, CA (US)

(21) Appl. No.: 15/154,820

(22) Filed: May 13, 2016

(51) Int. Cl. H04W 4/22; H04W 36/00; H04W 76/00; H04W 28/02; H04W 88/06

(52) U.S. Cl. CPC H04W 4/22; H04W 76/007; H04W 28/0215; H04W 36/0022; H04W 88/06

(57) ABSTRACT

A method for prioritizing a mobile originated emergency call over mobile terminated call signaling, includes: initiating an emergency call on a first subscription; determining whether a mobile terminated (MT) call is incoming on a second subscription; in response to determining that the MT call is incoming on the second subscription, aborting the MT call signaling; determining whether the first subscription is out of service; and in response to determining that the first subscription is not out of service completing the emergency call on the first subscription.

### BACKGROUND

Mobile Calls are broadly classified into Mobile Originated (MO) or Mobile Terminated (MT) calls. For a multi subscriber identity module (SIM) multi standby (MSMS) mobile communication device, an incoming MT call state may be unknown to a receiver of the call until a signaling or alerting message on a circuit switched (CS) supported network or a SIP_UPDATE for internet protocol (IP) Multimedia Subsystem (IMS) related signaling (e.g., long term evolution (LTE)) is received, or any other state that corresponds to a ringing state on a user interface occurs which an end user can identify.

When the user dials an emergency call (e.g., E911/911) or other high-priority call on a first subscription (Sub1) during signaling operations for an MT call on a second subscription (Sub2), the emergency or high-priority call on Sub1 may be suspended (e.g., put on hold) without the user's knowledge due to the related signaling for the incoming call on Sub2. Delays of 20 seconds or more in placing the emergency/high-priority call may result. FIG. 5 is a diagram illustrating delay in placing an emergency/high-priority call (e.g., E911) for a conventional mobile communication device.

Referring to FIG. 7, at block 710 an MT call may be incoming on Sub 1. At block 720, call set up signaling may take place between Sub1 and the communication network. The MT link may be established at block 730. If the user places an emergency call during call set up signaling and MT link establishment (i.e., blocks 720 and 730), the emergency call may be placed on hold until the MT link is aborted (i.e., the MT call is ended) at block 740. Finally, at block 750 the emergency call may be established.

The delay may be caused because the transceiver resource module (TRM) may assign a highest priority, which is the same priority as the MO E911 call, to the existing MT call. As a result, the TRM may grant control of the radio frequency (RF) chain to the subscription (e.g., Sub2) with the existing MT call and the emergency call might be put on hold without user knowledge. The problem may also occur in single SIM mobile communication devices.

Procedures/conditions that may result in delays in handling emergency or other high priority calls over various radio access technologies (RATs) may include, but are not limited to, registration signaling, extended service request and network response signaling, RAT search, page related procedures, radio bearer establishment signaling, etc.

In addition, for an MSMS mobile communication device with dual receive (DR) capabilities, the idle subscription (e.g., a global system for mobile communication (GSM) subscription) may receive paging messages during the circuit switched fall back (CSFB) procedure on the active subscription. The CSFB procedure may include redirecting the subscription from a packet-switched (PS) RAT, for example, but not limited to, 4G or LTE, to a circuit-switched (CS) RAT, for example, but not limited to 2G, 3G, code division multiple access (CDMA), or time division synchronous CDMA (TD-SCDMA).

During redirection the circuit-switched RAT may conduct network signaling procedures and other activities to properly establish the voice call. If the idle subscription receives a page during redirection, the MO or MT voice call on the active subscription may be dropped because paging messages on the idle subscription (e.g., a page for a voice call on the idle subscription) may take priority over the CSFB procedure until the voice call is completely established on the active subscription.

### SUMMARY

Apparatuses and methods for prioritizing a mobile originated emergency call over existing mobile terminated call related signaling are provided. Also provided are apparatuses and methods for enabling a mobile communication device to complete a CSFB procedure on a subscription in the event that another subscription receives paging messages during the CSFB procedure.

According to various aspects there is provided a method for prioritizing a mobile originated emergency call over mobile terminated call signaling. In some aspects, the method may include: initiating an emergency call on a first subscription; determining whether a mobile terminated (MT) call is incoming on a second subscription; in response to determining that the MT call is incoming on the second subscription, aborting the MT call signaling; determining whether the first subscription is out of service; and in response to determining that the first subscription is not out of service, completing the emergency call on the first subscription.

According to various aspects there is provided a mobile communication device. In some aspects, the mobile communication device may include: a communication unit including a radio frequency (RF) chain; a memory operably connected to the communication unit; and a control unit operably connected to the communication unit and the memory.

The control unit may be configured to: control the communication unit to initiate an emergency call on a first subscription; determine whether a mobile terminated (MT) call is incoming on a second subscription; in response to determining that the MT call is incoming on the second subscription, control the communication unit to abort MT call signaling; determine whether the first subscription is out of service; and in response to determining that the first subscription is not out of service, control the communication unit to complete the emergency call on the first subscription.

According to various aspects there is provided a method for prioritizing a mobile originated emergency call over mobile terminated call signaling. In some aspects, the method may include: initiating an emergency call on a first subscription; determining whether a mobile terminated (MT) call is incoming on a second subscription; in response to determining that the MT call is incoming on the second subscription, aborting MT call signaling; determining whether the first subscription is out of service; in response to determining that the first subscription is not out of service, completing the emergency call on the first subscription.

According to various aspects there is provided a mobile communication device. In some aspects, the mobile communication device may include: a communication unit including a radio frequency (RF) chain; a memory operably connected to the communication unit; and a control unit operably connected to the communication unit and the memory.

The control unit may be configured to: initiate an emergency call on a first subscription; determine whether a mobile terminated (MT) call is incoming on a second subscription; in response to determining that the MT call is incoming on the second subscription, abort MT call signaling; determine whether the first subscription is out of service; in response to determining that the first subscription is not out of service, complete the emergency call on the first subscription.

According to various aspects there is provided a method for establishing a voice call on a first subscription capable of utilizing a first radio access technology (RAT) and a second RAT on a mobile communication device. In some aspects, the method may include: triggering a circuit-switched fallback on the first subscription from the first RAT to the second RAT to establish the voice call; and locking a radio frequency (RF) resource of the mobile communication device by the first subscription until the voice call is established through the second RAT.

According to various aspects there is provided a mobile communication device. In some aspects, the mobile communication device may include: a radio frequency (RF) chain configured to support a first radio access technology (RAT) and a second RAT; and a control unit operatively coupled to the RF chain; and a memory operatively coupled to the control unit and the RF chain.

The control unit may be configured to: trigger a circuit-switched fallback (CSFB) on a first subscription from the first RAT to the second RAT to establish the CS voice call; and lock the RF chain for use by the first subscription until the CS voice call is established on the second RAT.

Other features and advantages should be apparent from the following description which illustrates by way of example aspects of the various teachings of the disclosure.

### BRIEF DESCRIPTION OF THE DRAWINGS

Aspects and features of the various examples will be more apparent by describing examples with reference to the accompanying drawings, in which:

FIG. 1A is a block diagram illustrating a mobile communication device according to various examples;

FIG. 1B is a diagram illustrating a network environment for various examples;

FIG. 2 is a diagram illustrating a sequence for placing an emergency/high-priority call according to various examples;

FIG. 3 is a flowchart illustrating a method for prioritizing a mobile originated emergency call over mobile terminated call signaling according to various examples;

FIG. 4 is a flowchart illustrating a method for prioritizing a mobile originated emergency call over mobile terminated call signaling according to various examples;

FIG. 5 is a communication flow diagram illustrating a CSFB procedure with RF resource locking on a mobile communication device according to various examples;

FIG. 6 is a flowchart illustrating a method for establishing a CS voice call on a first subscription capable of utilizing a first RAT and a second RAT on a mobile communication device according to various examples; and

FIG. 7 is a diagram illustrating delay in placing an emergency/high-priority call for a conventional mobile communication device.

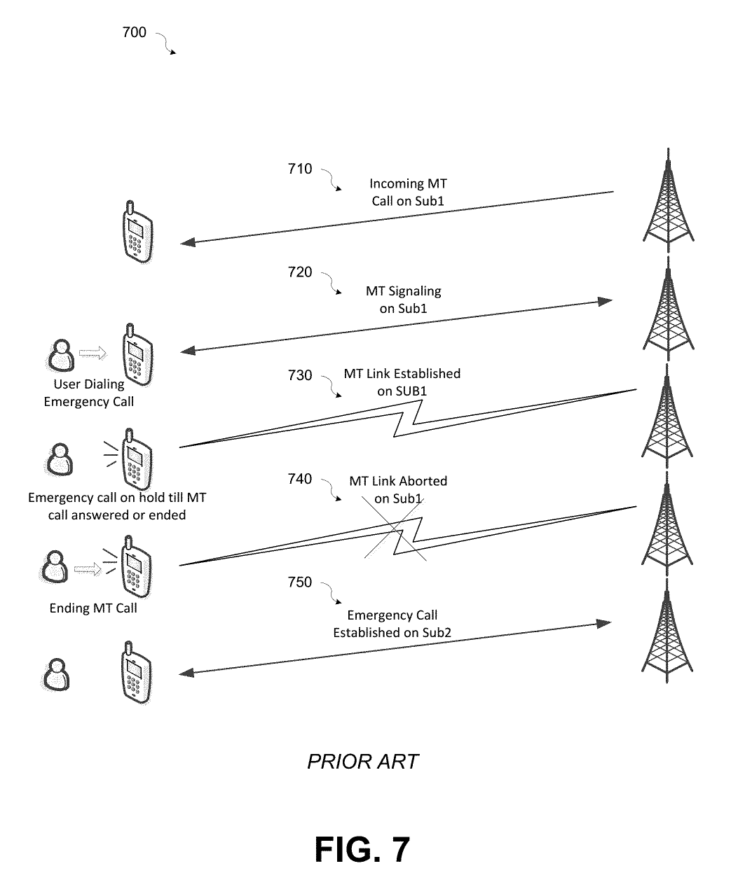

### DETAILED DESCRIPTION

While certain examples are described, these examples are presented by way of example only, and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection.

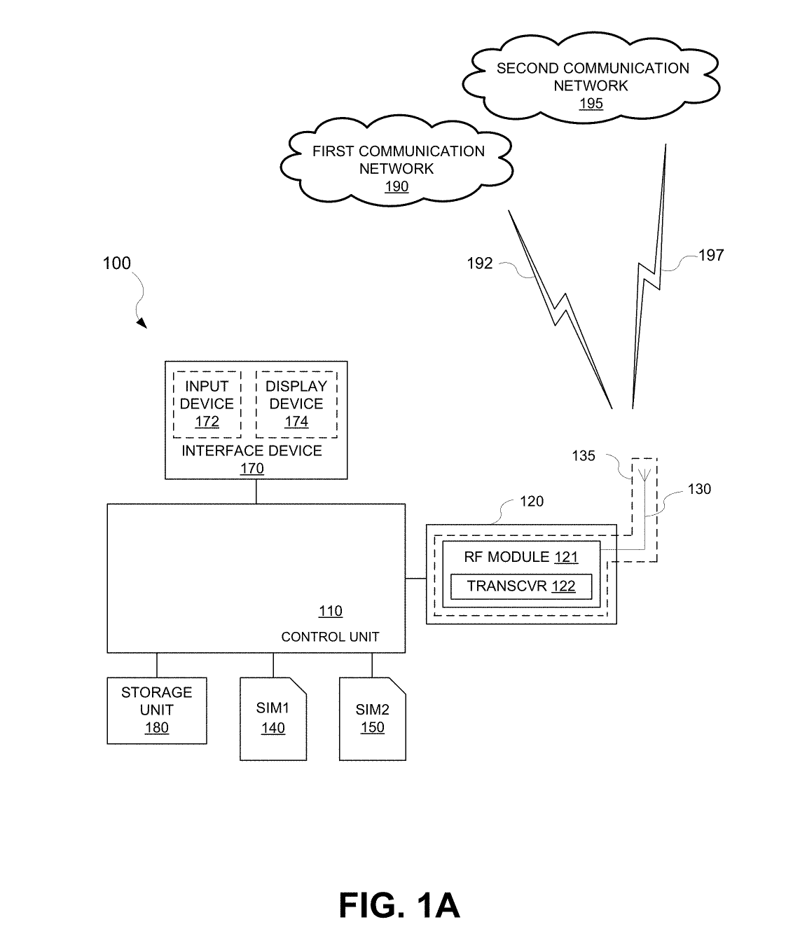

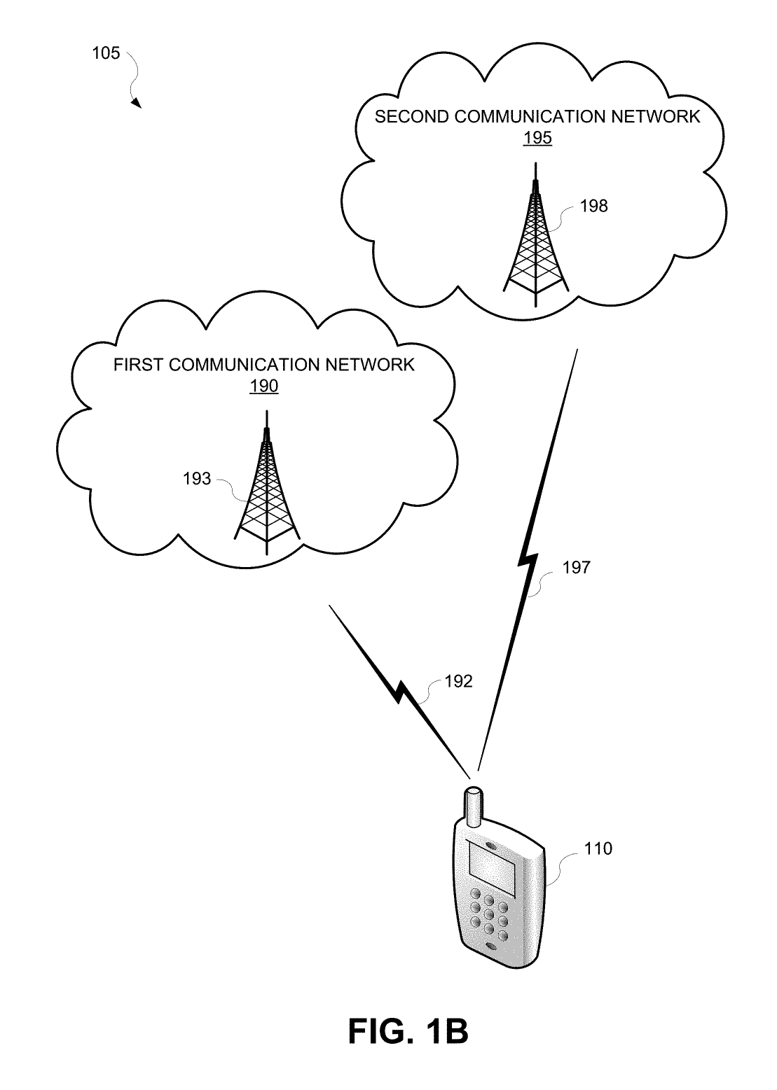

FIG. 1A is a block diagram illustrating a mobile communication device 100 according to various examples. As illustrated in FIG. 1, the mobile communication device 100 may include a control unit 110, a communication unit 120, an antenna 130, a first subscriber identity module (SIM) 140, a second SIM 150, a user interface device 170, and a memory 180.

The mobile communication device 100 may be, for example but not limited to, a mobile telephone, smartphone, tablet, computer, etc., capable of communications with one or more wireless networks. One of ordinary skill in the art will appreciate that the mobile communication device 100 may include one or more transceivers (communication units) and may interface with one or more antennas without departing from the scope of protection.

The communication unit 120 may include, for example, but not limited to, an RF module 121. The RF module 121 may include, for example, but not limited to the first transceiver 122. An RF chain 135 may include, for example, but not limited to, the antenna 130 and the RF module 121.

One of ordinary skill in the art will appreciate that examples of the mobile communication device 100 may include more than one communication unit and/or more than one antenna without departing from the scope of protection.

A SIM (for example the first SIM 140 and/or the second SIM 150) in various examples may be a universal integrated circuit card (UICC) that is configured with SIM and/or universal SIM (USIM) applications, enabling access to global system for mobile communications (GSM) and/or universal mobile telecommunications system (UMTS) networks. The UICC may also provide storage for a phone book and other applications. Alternatively, in a code division multiple access (CDMA) network, a SIM may be a UICC removable user identity module (R-UIM) or a CDMA subscriber identity module (CSIM) on a card. A SIM card may have a CPU, ROM, RAM, EEPROM and I/O circuits. An integrated circuit card identity (ICCID) SIM serial number may be printed on the SIM card for identification. However, a SIM may be implemented within a portion of memory of the mobile communication device 100, and thus need not be a separate or removable circuit, chip, or card.

A SIM used in various examples may store user account information, an international mobile subscriber identity (IMSI), a set of SIM application toolkit (SAT) commands, and other network provisioning information, as well as provide storage space for phone book database of the user's contacts. As part of the network provisioning information, a SIM may store home identifiers (e.g., a system identification number (SID)/network identification number (NID) pair, a home public land mobile network (HPLMN) code, etc.) to indicate the SIM card network operator provider.

The first SIM 140 may associate the communication unit 120 with a first subscription (Sub1) 192 associated with a first radio access technology (RAT) on a first communication network 190 and the second SIM 150 may associate the communication unit 120 with a second subscription (Sub2) 197 associated with a second RAT on a second communication network 195. When a RAT is active, the communication unit 120 receives and transmits signals on the active RAT. When a RAT is idle, the communication unit 120 receives but does not transmit signals on the idle RAT.

For convenience, the various examples are described in terms of dual SIM dual standby (DSDS) mobile communication devices. However, one of ordinary skill in the art will appreciate that the various examples may be extended to Multi-SIM Multi-Standby (MSMS) and/or Multi-SIM Multi-Active (MSMA) mobile communication devices without departing from the scope of protection.

The first communication network 190 and the second communication network 195 may be operated by the same or different service providers, and/or may support the same or different RATs, for example, but not limited to, GSM, CDMA, wideband CDMA (WCDMA), long term evolution (LTE), Wifi, and Fifth Generation (5G) wireless technologies.

The user interface device 170 may include an input device 172, for example, but not limited to a keyboard, touch panel, or other human interface device, and a display device 174, for example, but not limited to, a liquid crystal display (LCD), light emitting diode (LED) display, or other video display. One of ordinary skill in the art will appreciate that other input and display devices may be used without departing from the scope of the various examples.

The control unit 110 may be configured to control overall operation of the mobile communication device 100 including control of the communication unit 120, the user interface device 170, and the memory 180. The control unit 110 may be a programmable device, for example, but not limited to, a microprocessor (e.g., general-purpose processor, baseband modem processor, etc.) or microcontroller.

The memory 180 may be configured to store operating systems and/or application programs for operation of the mobile communication device 100 that are executed by the control unit 110, as well as to store application data and user data.

FIG. 1B is a diagram illustrating a network environment 105 for various examples. Referring to FIGS. 1A and 1B, a mobile communication device 100 may be configured to communicate with a first communication network 190 on a first subscription 192 and a second communication network 195 on a second subscription 197. One of ordinary skill in the art will appreciate that the mobile communication device may configured to communicate with more than two communication networks and may communicate on more than two subscriptions without departing from the scope of protection.

The first communication network 190 and the second communication network 195 may implement the same or different radio access technologies (RATs). For example, the first communication network 190 may be an LTE network and the first subscription 192 may be an LTE subscription. The second communication network 195 may be a GSM network and the second subscription 197 may be a GSM subscription. Alternatively, the first communication network 190 and/or second communication network 195 may implement another RAT including, for example, but not limited to, LTE, WCDMA, Time Division-Synchronous Code Division Multiple Access (TD-SCDMA)), Wifi, and Fifth Generation (5G) wireless technologies.

The first communication network 190 may include one or more base transceiver stations (BTSs) including, for example, but not limited to, a first BTS 193. The second communication network 195 may also include one or more BTSs, including, for example, but not limited to, a second BTS 198. A person having ordinary skill in the art will appreciate that the network environment 105 may include any number of communication networks, mobile communication devices, and BTSs without departing from the scope of the various examples.

The mobile communication device 100 may attempt to acquire the first communication network 190 and camp on the first BTS 193. The mobile communication device 100 may also attempt to acquire the second communication network 195 and camp on the second BTS 198. A person having ordinary skill in the art will appreciate that the acquisition of the first communication network 190 performed on the first subscription 192 may be independent of the acquisition of the second communication network 195 performed on the second subscription 197. Furthermore, the mobile communication device 100 may attempt to acquire the first communication network 190 on the first subscription 192 and the second communication network 195 on the second subscription 197.

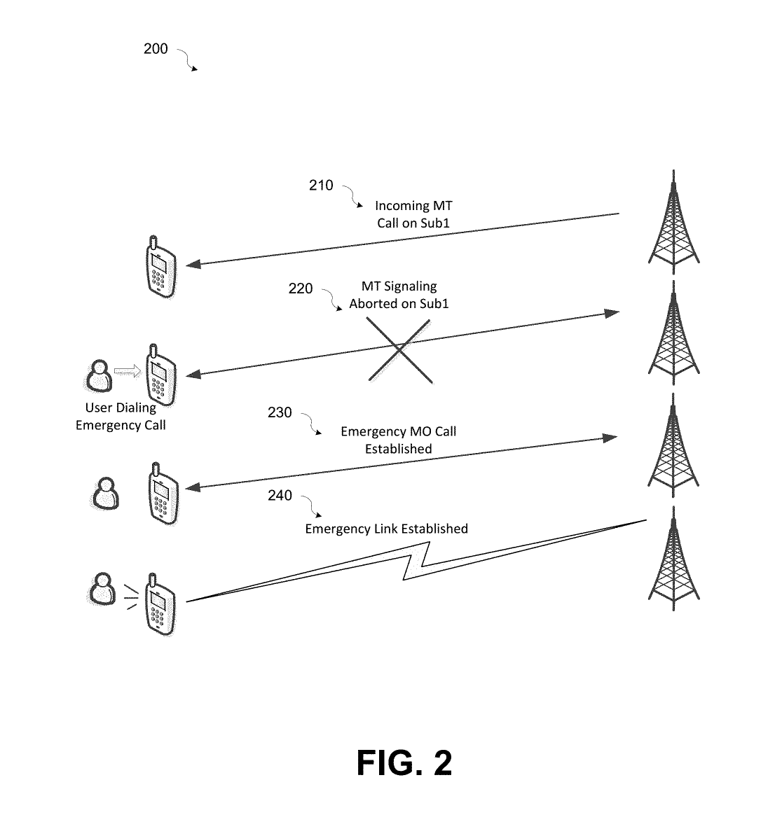

FIG. 2 is a diagram 200 illustrating a sequence for placing an emergency/high-priority call according to various examples. Referring to FIGS. 1A-2, at block 210 an MT call may be incoming on Sub1 192. At block 220, the MT call signaling may be taking place between Sub1 192 and the communication network (e.g., the first communication network 190) may be aborted. For example, the control unit 110 may control the communication unit 120 to abort the MT call signaling taking place between Sub1 192 and the first communication network 190. At block 230 the emergency call may be established and at block 240 the emergency link may be established, i.e., the emergency call may be placed.

High priority, time critical calls may be for example, but not limited to, high priority MO CS Calls (e.g., emergency calls). In addition, MT CS call signaling (i.e., call set up signaling) may have a high priority. Thus, with an MSMS mobile communication device (e.g., the mobile communication device 100), a high priority MO CS call on one subscription (e.g., Sub1 192) may be delayed by MT CS call signaling on another subscription (e.g., Sub2 197). Similarly, a high priority MO CS call on Sub2 197) may be delayed by MT CS call signaling on Sub1 192.

In various examples, the MT call signaling may be aborted and the MO call may be allowed on the calling subscription. The MT call may be a CS call. For example, the MO CS call may be allowed on the calling subscription where the MT subscription might be searching for service and not actively in a signaling state. Alternatively, the MO CS call may be allowed on the calling subscription where MO call is a voice over LTE (VoLTE) call and the MT call is CS call (or vice versa) where the MO VoLTE call cannot be transferred across the subscriptions.

In various examples, the MT call signaling may be aborted and the MO CS call allowed on the same subscription on which MT call signaling was aborted. The MT call may be a CS call. For example, the MO CS call may be allowed on the same subscription on which the MT CS call signaling was aborted where the MT Subscription was in active signaling. Since the MT Subscription may already be in a radio resource control (RRC) Connected state, placing the MO call may be faster to on this subscription.

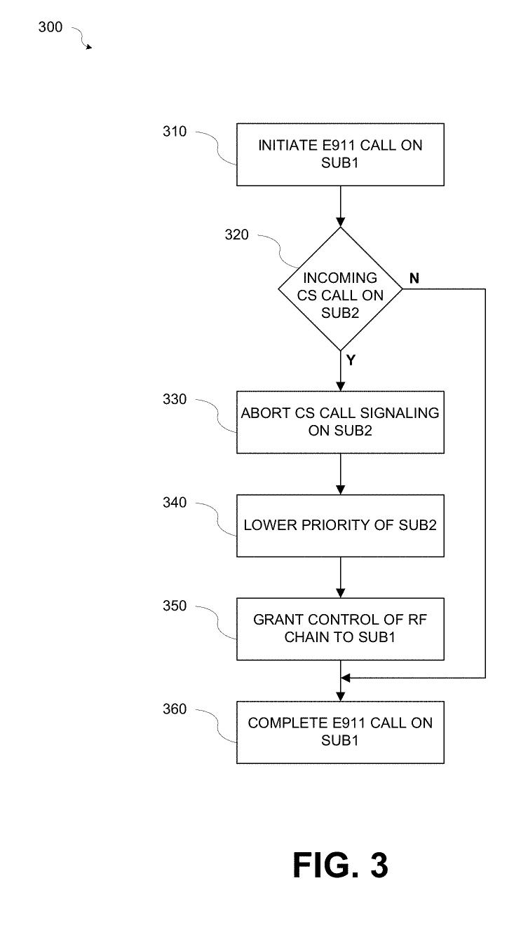

FIG. 3 is a flowchart illustrating a method 300 for prioritizing a mobile originated emergency call over existing mobile terminated call related signaling according to various examples. Referring to FIGS. 1A, 1B, and 3, at block 310 an emergency call may be initiated on a first subscription (e.g., Sub1 192). For example, the control unit 110 may accept an input via the input device 172 of the user interface device 170 indicating an emergency call should be placed. The control unit 110 may control the communication unit 120 to initiate the emergency call on Sub1 192.

At block 320 the control unit 110 may determine whether a MT call is incoming on a second subscription (e.g., Sub2 197). The MT call may be a CS call. In response to determining that a CS MT call is not incoming on Sub2 197 (330-N), at block 360 the control unit 110 may control the communication unit 120 to complete the emergency call on Sub1 192.

In response to determining that a MT CS call is incoming on Sub2 197 (330-Y), at block 330 the control unit 110 may control the communication unit 120 to abort the MT CS call signaling on Sub2 197. At block 340 the control unit 110 may lower the priority of Sub2 197. For example, the control unit 110 may set the priority of Sub2 197 to a priority lower than the priority of Sub1 192 thereby enabling Sub1 192 to take precedence in gaining control of the RF chain 135.

At block 350, the control unit 110 may grant control of the RF chain 135 to Sub1 192. At block 360 the control unit 110 may control the communication unit 120 to complete the emergency call on Sub1 192.

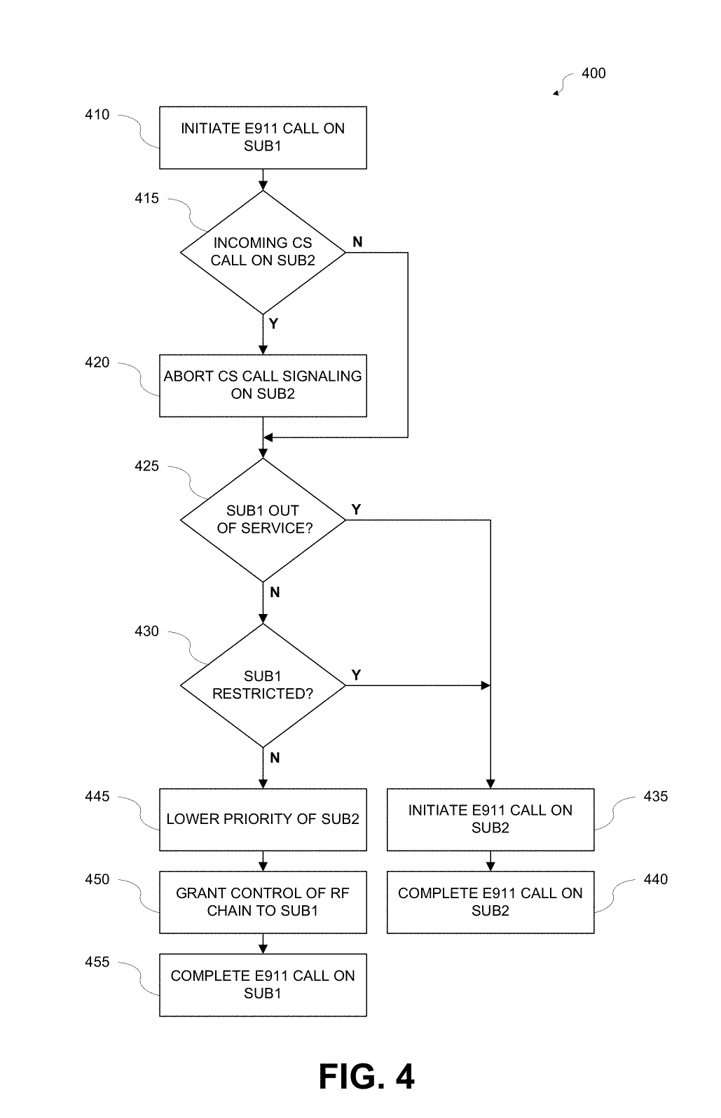

FIG. 4 is a flowchart illustrating a method 400 for prioritizing a mobile originated emergency call over existing mobile terminated call related signaling according to various examples. Referring to FIGS. 1A, 1B, and 4, at block 410 an emergency call may be initiated on a first subscription (e.g., Sub1 192). For example, the control unit 110 may accept an input via the input device 172 of the user interface device 170 indicating an emergency call should be placed. The control unit 110 may control the communication unit 120 to initiate the emergency call on Sub1 192.

At block 415 the control unit 110 may determine whether a MT call is incoming on a second subscription (e.g., Sub2 197). The MT call may be a CS call. In response to determining that an MT CS call is incoming on Sub2 197 (415-Y), at block 420 the control unit 110 may control the communication unit 120 to abort the MT CS call signaling on Sub2 197. In response to determining that a MT CS call is not incoming on Sub2 197 (415-N), at block 425 the control unit 110 may determine whether Sub1 192 is out of service. For example, the Sub1 192 may be in handover or may be in an area with no service.

In response to determining that Sub1 192 is out of service (425-Y), at block 435 the control unit 110 may control the communication unit 120 to initiate the emergency call on Sub2 197. For example, for an MT CS voice call, once a radio resource control (RRC) connection is established, the mobile communication device may exchange call setup requirements (i.e., signaling) with the network. An RRC link may have been established on Sub2 197 prior to the MT CS call signaling being aborted. The control unit 110 may control the communication unit 120 to initiate the emergency call on the already established RRC link on Sub2 197. At block 440, the control unit 110 may control the communication unit 120 to complete the emergency call on Sub2 197.

In response to determining that Sub1 192 is not out of service (425-N), at block 430 the control unit 110 may determine whether Sub1 192 is restricted. For example, the control unit 110 may determine whether Sub1 192 is not permitted to place emergency calls on the communication network (e.g., the first communication network 190) to which it is connected. In response to determining that Sub1 192 is restricted (430-Y), at block 435 the control unit 110 may control the communication unit 120 to initiate the emergency call on Sub2 197. At block 440, the control unit 110 may control the communication unit 120 to complete the emergency call on Sub2 197.

In response to determining that Sub1 192 is not restricted (430-N), at block 445 the control unit 110 may lower the priority of Sub2 197. For example, the control unit 110 may lower the priority of Sub2 197 to a priority lower than the priority of Sub1 192. Lowering the priority of Sub2 197 may permit Sub1 192 to gain control of the RF chain (e.g., the RF chain 135) to complete the emergency call. At block 450, the control unit 110 may cause the communication unit 120 to grant control of the RF chain 135 to Sub1 192. At block 455, the control unit 110 may control the communication unit 120 to complete the emergency call on Sub1 192.

The methods 300 and 400, respectively, may be embodied on a non-transitory computer readable medium, for example, but not limited to, the memory 180 or other non-transitory computer readable medium known to those of skill in the art, having stored therein a program including computer executable instructions for making a processor, computer, or other programmable device execute the operations of the methods.

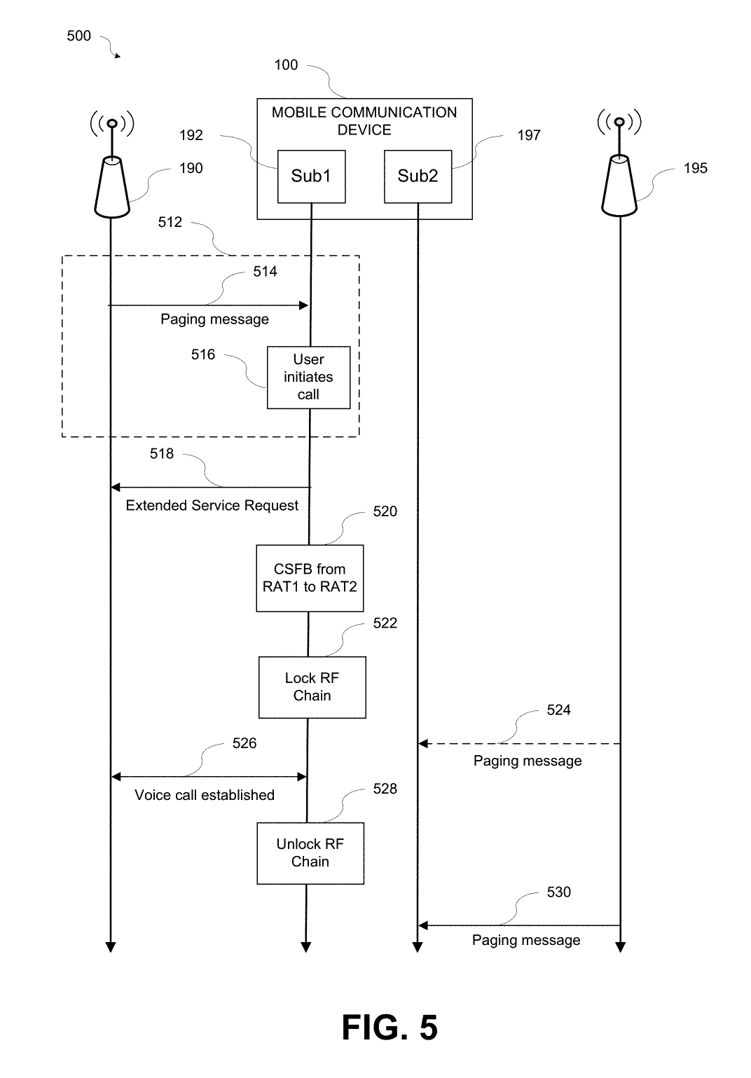

In various examples, the RF chain may be locked by a first subscription performing CSFB to prevent dropping and MO or MT voice call during the CSFB when a paging message is received by a second subscription. FIG. 5 is a communication flow diagram illustrating a CSFB procedure 500 with RF chain locking on a mobile communication device to various examples. Referring to FIGS. 1A, 1B, and 5, the mobile communication device 100 may include a first subscription (e.g., Sub1 192 and a second subscription (e.g., Sub2 197).

Sub1 192 may communicate with the first communication network 190 on a first RAT or a second RAT. The first RAT may be a PS RAT, for example, but not limited to, LTE, while the second RAT may be a CS RAT, for example, but not limited to CDMA or TD-SCDMA. Sub2 197 may communicate with the second communication network 195 through a legacy RAT, for example, but not limited to, GSM.

The mobile communication device 100 may include an RF chain (e.g., the RF chain 135) that may be shared by the Sub1 192 and Sub2 197 (e.g., in a DSDS communication device). The RF chain 135 may have DR capability. For example, the RF chain 135 may permit both Sub1 192 and Sub2 197 to receive paging messages and other information from the first communication network 190 and the second communication network 195, respectively, while the RF chain 135 is shared between Sub1 192 and Sub2 197. However, only the active subscription may transmit information at a given time.

Sub1 192 may be active and utilizing the first RAT (e.g., the PS RAT) when a CS voice call is initiated on Sub1 192 in operation 512. Initiation of the CS voice call may either be a first paging message 514 indicating an incoming voice call on Sub1 192 (e.g., an MT call), or a user input 516 initiating a voice call on Sub1 192 (e.g., an MO call).

Sub1 192 may then send an extended service request (ESR) 518 to the first communication network 190. The ESR 518 may notify the first communication network 190 that Sub1 192 is initiating a CSFB to respond to the voice call. The ESR 518 may be sent after receiving the first paging message 514 from the first communication network 190 or may be sent after the user input 516 initiates a voice call on the mobile communication device 100.

Sub1 192 may then initiate a CSFB 520 to redirect Sub1 192 from the first RAT to the second RAT in order to establish the CS voice call. At operation 522, the mobile communication device 100 may lock the RF chain 135 during the CSFB 520 so that only Sub1 192 may utilize the RF chain 135. Locking the RF chain 135 for exclusive use by Sub1 192 may prevent Sub2 197 from receiving messages from the second communication network 195. For example, the second communication network 195 may send a second paging message 524 to the mobile communication device 100 during the redirection of Sub1 192 from the first RAT to the second RAT. Because the RF chain 135 is locked for use by Sub1 192, Sub2 197 may not receive the second paging message 524, and thus the voice call on Sub1 192 may not be dropped during the CSFB 520. Once the redirection from the first RAT to the second RAT is complete and the CS voice call is established on Sub1 192 at operation 526, the RF chain 135 may be unlocked from Sub1 192 to allow sharing the RF chain 135 thereby permitting Sub2 197 to once again receive pages from the second communication network 195.

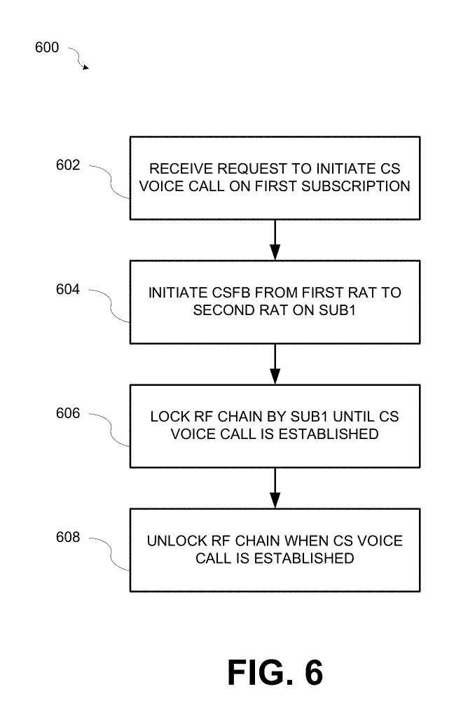

FIG. 6 is a flowchart illustrating a method for establishing a CS voice call on a first subscription capable of utilizing a first RAT and a second RAT on a mobile communication device according to various examples. Referring to FIGS. 1A, 1B, 5, and 6, the mobile communication device 100 may include a first subscription (e.g., Sub1 192) and a second subscription (e.g., Sub2 197). Sub1 192 may communicate with the first communication network 190 on a first RAT or a second RAT. The first RAT may be a PS RAT, for example, but not limited to, LTE, while the second RAT may be a CS RAT, for example, but not limited to CDMA or TD-SCDMA. Sub2 197 may communicate with the second communication network 195 through a legacy RAT, for example, but not limited to, GSM.

The mobile communication device 100 may include an RF chain (e.g., the RF chain 135) that may be shared by Sub1 192 and Sub2 197 (e.g., in a DSDS communication device). The RF chain 135 may have DR capability. For example, the RF chain 135 may permit, both Sub1 192 and Sub2 197 to receive paging messages and other information from the first communication network 190 and the second communication network 195, respectively, while the RF chain 135 is shared between Sub1 192 and Sub2 197. However, only the active subscription may transmit information at a given time.

Referring to FIG. 6, at block 502, a request may be received to initiate a CS voice call on Sub1 192. For example, the control unit 110 of the mobile communication device 100 may receive a request to initiate a CS voice call on Sub1 192. The request may be, for example, a paging message received from the first communication network 190 indicating an incoming CS voice call (e.g., an MT call), or the request may be a user input on the mobile communication device 100 initiating a CS voice call (e.g., an MO call). The request may be received while Sub1 192 is utilizing the first RAT for a PS call.

At block 604, the device processor may initiate a CSFB on Sub1 192 from the first RAT to the second RAT. For example, the control unit 110 may cause the communication unit 120 to perform a CSFB from the first RAT to the second RAT. The CSFB may be initiated to enable Sub1 192 to receive or place the CS voice call.

At block 605, the RF chain 135 may be locked for use by Sub1 192 during the CSFB until the CS voice call is fully established on Sub1 192 on the second RAT. For example, the control unit 110 may cause a flag or other data value to be set. The flag or other data value may indicate that only Sub1 192 may utilize the RF chain 135. The flag or other data value may be set, for example, but not limited to, in memory internal to the control unit 110 or in the memory 180. Locking the RF chain 135 for exclusive use by Sub1 192 may prevent Sub2 197 from receiving paging messages from the second communication network 195 that may disrupt the CSFB process and cause the CS voice call to drop.

At block 608, after the CS voice call is established on Sub1 192 on the second RAT, the RF chain 135 may be unlocked from Sub1 192. For example, the control unit 110 may cause the flag or other data value that was set to indicate that only Sub1 192 may utilize the RF chain 135 to be reset. Resetting the flag or other data value may unlock the RF chain 135 from Sub1 192 and allow sharing the RF chain 135 thereby permitting Sub2 197 to again receive information from the second communication network 195. In this manner, the method 600 may permit completion of the CSFB procedure.

The method 600 may be embodied on a non-transitory computer readable medium, for example, but not limited to, the memory 180 or other non-transitory computer readable medium known to those of skill in the art, having stored therein a program including computer executable instructions for making a processor, computer, or other programmable device execute the operations of the methods.

The various examples illustrated and described are provided merely as examples to illustrate various features of the claims. However, features shown and described with respect to any given embodiment are not necessarily limited to the associated embodiment and may be used or combined with other examples that are shown and described. Further, the claims are not intended to be limited by any one example embodiment.

The accompanying claims and their equivalents are intended to cover such forms or modifications as would fall within the scope and spirit of the protection. For example, the example apparatuses, methods, and systems disclosed herein can be applied to multi-SIM wireless devices subscribing to multiple communication networks and/or communication technologies. The various components illustrated in the figures may be implemented as, for example, but not limited to, software and/or firmware on a processor, ASIC/FPGA/DSP, or dedicated hardware. Also, the features and attributes of the specific example examples disclosed above may be combined in different ways to form additional examples, all of which fall within the scope of the present disclosure.

The foregoing method descriptions and the process flow diagrams are provided merely as illustrative examples and are not intended to require or imply that the operations of the various examples must be performed in the order presented. As will be appreciated by one of skill in the art the order of operations in the foregoing examples may be performed in any order. Words such as “thereafter,” “then,” “next,” etc., are not intended to limit the order of the operations; these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and algorithm operations described in connection with the examples disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the various examples.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Although the present disclosure provides certain example examples and applications, other examples that are apparent to those of ordinary skill in the art, including examples which do not provide all of the features and advantages set forth herein, are also within the scope of this disclosure. Accordingly, the scope of the present disclosure is intended to be defined only by reference to the appended claims.

What is claimed is:

1. A method for prioritizing a mobile originated emergency call over mobile terminated call signaling, the method comprising:
initiating an emergency call on a first subscription;
determining whether a mobile terminated (MT) call is incoming on a second subscription;
in response to determining that the MT call is incoming on the second subscription, aborting the MT call signaling;
determining whether the first subscription is out of service; and
in response to determining that the first subscription is not out of service, completing the emergency call on the first subscription.

2. The method of claim 1, wherein the MT call is a circuit switched (CS) call.

3. The method of claim 1, further comprising:
after the aborting the call signaling for the MT call, lowering a priority for the second subscription.

4. The method of claim 1, further comprising:
after aborting the MT call signaling, granting control of a radio frequency (RF) chain to the first subscription.

5. The method of claim 1, further comprising:
in response determining that an MT call is not incoming on the second subscription, completing the emergency call on the first subscription.

6. The method of claim 1, further comprising:
in response to determining that the first subscription is out of service:
initiating the emergency call on the second subscription; and
completing the emergency call on the second subscription.

7. The method of claim 1, further comprising:
prior to completing the emergency call on the first subscription:
lowering a priority of the second subscription; and
based on the lower priority of the second subscription, granting control of a radio frequency (RF) chain to the first subscription having a higher priority than the second subscription.

8. The method of claim 1, further comprising:
prior to completing the call on the first subscription, determining if the first subscription is restricted;
in response to determining that the first subscription is restricted, initiating the emergency call on the second subscription.

9. The method of claim 8, further comprising:
in response to determining that the first subscription is not restricted:
lowering a priority of the second subscription; and
based on the lower priority of the second subscription, granting control of a radio frequency (RF) chain to the first subscription having a higher priority than the second subscription.

10. A mobile communication device, comprising:
a communication unit including a radio frequency (RF) chain;
a memory operably connected to the communication unit; and
a control unit operably connected to the communication unit and the memory and configured to:
control the communication unit to initiate an emergency call on a first subscription;
determine whether a mobile terminated (MT) call is incoming on a second subscription;
in response to determining that the MT call is incoming on the second subscription, control the communication unit to abort MT call signaling;
determine whether the first subscription is out of service; and
in response to determining that the first subscription is not out of service, control the communication unit to complete the emergency call on the first subscription.

11. The mobile communication device of claim 10, wherein the MT call is a circuit switched (CS) call.

12. The mobile communication device of claim 10, wherein after controlling the communication unit to abort the MT call signaling, the control unit lowers a priority for the second subscription.

13. The mobile communication device of claim 10, wherein after controlling the communication unit to abort the MT call signaling, the control unit controls the communication unit to grant control of the RF chain to the first subscription.

14. The mobile communication device of claim 10, wherein in response determining that an MT call is not incoming on the second subscription, the control unit controls the communication unit to complete the emergency call on the first subscription.

15. The mobile communication device of claim 10, wherein in response determining that the first subscription is out of service, the control unit controls the communication unit to:
initiate the emergency call on the second subscription; and
complete the emergency call on the second subscription.

16. The mobile communication device of claim 10, wherein prior to completing the emergency call on the first subscription the control unit:
lowers a priority of the second subscription; and
based on the lower priority of the second subscription, grants control of the radio frequency (RF) chain to the first subscription having a higher priority than the second subscription.

17. The mobile communication device of claim 10, wherein prior to completing the emergency call on the first subscription, the control unit:
determines whether the first subscription is restricted; and
in response to determining that the first subscription is restricted, controls the communication unit to initiate the emergency call on the second subscription.

18. The mobile communication device of claim 17, wherein in response to determining that the first subscription is not restricted, the control unit:
lowers a priority of the second subscription; and
based on the lower priority of the second subscription, grants control of the radio frequency (RF) chain to the first subscription having a higher priority than the second subscription.

19. A method for establishing a circuit switched (CS) voice call on a first subscription capable of utilizing a first radio access technology (RAT) and a second RAT on a mobile communication device, the method comprising:
triggering a circuit-switched fallback (CSFB) on the first subscription from the first RAT to the second RAT to establish the CS voice call; and
locking a radio frequency (RF) chain of the mobile communication device for use by the first subscription until the CS voice call is established through the second RAT.

20. The method of claim 19, wherein locking the RF chain prevents a second subscription on the mobile communication device from receiving paging messages through the RF chain.

21. The method of claim 19, further comprising unlocking the RF chain after the CS voice call is established through the second RAT.

22. The method of claim 19, wherein the RF chain has dual receive capability.

23. The method of claim 19, wherein the CS voice call is a mobile originated (MO) call.

24. The method of claim 19, wherein the CS voice call is a mobile terminated (MT) call.

25. The method of claim 19, wherein the first RAT supports packet-switched (PS) communication and the second RAT supports CS communication.

26. A mobile communication device, comprising:
a radio frequency (RF) chain configured to support a first radio access technology (RAT) and a second RAT; and
a control unit operatively coupled to the RF chain; and
a memory operatively coupled to the control unit and the RF chain,
wherein the control unit is configured to:
trigger a circuit-switched fallback (CSFB) on a first subscription from the first RAT to the second RAT to establish a CS voice call; and
lock the RF chain for use by the first subscription until the CS voice call is established on the second RAT.

27. The mobile communication device of claim 26, wherein the control unit is configured to set a flag in the memory to lock the RF chain for use by the first subscription.

28. The mobile communication device of claim 26, wherein the control unit is configured to unlock the RF chain after the CS voice call is established through the second RAT.

29. The mobile communication device of claim 28, wherein the control unit is configured to reset a flag in the memory to unlock the RF chain from exclusive use by the first subscription.

30. The mobile communication device of claim 26, wherein the RF chain operates in a dual receive mode.
